(19) United States
(12) Patent Application Publication
(10) Pub. No.: US 2025/0300488 A1
(43) Pub. Date: Sep. 25, 2025

(54) POWER SUPPLY CIRCUIT AND ENERGY STORAGE DEVICE

(71) Applicant: SHENZHEN HELLO TECH ENERGY CO., LTD, Shenzhen (CN)

(72) Inventors: Wenhai LIN, Shenzhen (CN); Zhongwei SUN, Shenzhen (CN); Gaosong SHEN, Shenzhen (CN); Feiyan LUO, Shenzhen (CN)

(21) Appl. No.: 19/230,141

(22) Filed: Jun. 6, 2025

Related U.S. Application Data
(63) Continuation of application No. PCT/CN2025/072074, filed on Jan. 13, 2025.

(30) Foreign Application Priority Data
Oct. 8, 2024 (CN) 202411404948.3
Oct. 8, 2024 (CN) 202422444826.9

(51) Int. Cl. H02J 9/06; H02M 1/00

(52) U.S. Cl. CPC H02J 9/062; H02M 1/007

(57) ABSTRACT

A power supply circuit and an energy storage device are disclosed. AC input and output interfaces of the power supply circuit are electrically connected to each other to form a first branch circuit. The AC input interface, a first AC/DC conversion module, a second AC/DC conversion module, and the AC output interface are sequentially electrically connected to form a second branch circuit. First branch circuit is configured to output electric energy from the external AC power supply when available through the AC output interface. Second branch circuit is configured to output electric energy to the AC output interface through the second branch circuit by using the external AC power supply when the external AC power supply is available, and to output electric energy to the AC output interface through the second AC/DC conversion module by using a battery module when the external AC power supply is unavailable.

### CROSS-REFERENCE TO RELATED APPLICATIONS

This application is a continuation application of International Application No. PCT/CN2025/072074, filed on Jan. 13, 2025, which claims priority to and benefits of Chinese Patent Application No. 202411404948.3, filed with China National Intellectual Property Administration on Oct. 8, 2024, and Chinese Patent Application No. 202422444826.9, filed with China National Intellectual Property Administration on Oct. 8, 2024, the entire disclosures of which are incorporated herein by reference.

### FIELD

The present disclosure relates to the field of energy storage device technologies, and particularly, to a power supply circuit and an energy storage device.

### BACKGROUND

A UPS (Uninterruptible Power System) is a device that can continuously supply power to a load. The UPS is typically composed of a rectifier, an inverter, and a battery group. The UPS includes a standby UPS and an online UPS.

In the online UPS, power is supplied to the load by the inverter. This type of UPS has a stable output, but has capacity loss when supplying the power to the load by the inverter. In the standby UPS, when an input power supply is normal, power is directly supplied by an external alternating current, AC, power supply. When the input power supply is interrupted, power is supplied by a battery module through inversion. This type of UPS has a simple structure and low cost, but is poor in output voltage stability and has a switching time period.

However, the single online UPS or the single standby UPS cannot adapt to different loads requirements, resulting in poor UPS flexibility and inability to meet user needs in different scenarios.

### SUMMARY

Embodiments of the present disclosure provide a power supply circuit and an energy storage device to solve at least one of the above technical problems.

A power supply circuit according to embodiments of the present disclosure includes an AC input interface, a first AC/DC conversion module, a second AC/DC conversion module, and an AC output interface. The AC input interface is configured to be connected to an external AC power supply. Each of the first AC/DC conversion module and the second AC/DC conversion module is configured to be connected to a battery module. The AC input interface and the AC output interface are electrically connected to each other to form a first branch circuit. The AC input interface, the first AC/DC conversion module, the second AC/DC conversion module, and the AC output interface are sequentially electrically connected to form a second branch circuit. The first branch circuit is configured to output electric energy through the AC output interface by using the external AC power supply when the external AC power supply is available; and the second branch circuit is configured to output electric energy to the AC output interface through the second branch circuit by using the external AC power supply when the external AC power supply is available, and/or the second branch circuit is configured to output electric energy to the AC output interface through the second AC/DC conversion module by using the battery module when the external AC power supply is available or unavailable.

In the power supply circuit described above, when the external AC power supply is available, the external AC power supply can output the electrical energy to the AC output interface or charge the battery module. Moreover, the battery module can be used to output the electric energy to the AC output interface regardless of whether the external AC power supply is available or not. In this way, the power supply circuit can simultaneously realize functions of an online UPS and a standby UPS, thereby making the power supply circuit highly flexible and suitable for different load requirements.

In some embodiments, the AC output interface includes a first AC output interface and a second AC output interface. The AC input interface and the first AC output interface are connected to each other to form the first branch circuit. The AC input interface, the first AC/DC conversion module, the second AC/DC conversion module, and the second AC output interface are sequentially electrically connected to form the second branch circuit.

In some embodiments, the first AC/DC conversion module includes a first AC/DC sub-conversion module and a first DC/DC conversion module connected to the first AC/DC sub-conversion module; and the second AC/DC conversion module includes a second AC/DC sub-conversion module and a second DC/DC conversion module connected to the second AC/DC sub-conversion module. The first AC/DC sub-conversion module is connected to the AC input interface; the second AC/DC sub-conversion module is connected to the second AC output interface; and the first DC/DC conversion module and the second DC/DC conversion module are connected to each other and are both connected to the battery module.

In some embodiments, the power supply circuit further includes a first switch disposed between the first AC/DC sub-conversion module and the second AC/DC sub-conversion module. The first switch is configured to control the first AC/DC sub-conversion module to be in conduction with or to be not in conduction with the second AC/DC sub-conversion module. The AC input interface is connected to the first AC/DC conversion module and the second AC/DC conversion module. When the first switch is turned on, two-phase power is inputted through the AC input interface and supplied to the battery module through the first AC/DC conversion module and the second AC/DC conversion module.

In some embodiments, the power supply circuit further includes a second switch disposed between the first AC output interface and the second AC output interface. The second switch is configured to enable the first AC output interface to be in conduction with or to be not in conduction with the second AC output interface. When the second switch is turned on, the first AC output interface and the second AC output interface are simultaneously powered through the AC input interface.

In some embodiments, when the second switch is turned on, one of the first branch circuit and the second branch circuit is switched on, and another one of the first branch circuit and the second branch circuit is switched off.

In some embodiments, the power supply circuit further includes a third AC output interface. The AC input interface includes a first live wire terminal and a second live wire terminal. The third AC output interface includes a third live wire terminal and a fourth live wire terminal. When power is supplied to the third AC output interface from the battery module, the third live wire terminal is connected to the first AC/DC conversion module, and the fourth live wire terminal is connected to the second AC/DC conversion module; and when power is supplied to the third AC output interface from the AC input interface, the first live wire terminal is connected to the third live wire terminal, and the second live wire terminal is connected to the fourth live wire terminal.

In some embodiments, the second branch circuit is further configured to charge the battery module by using the second branch circuit when the external AC power supply is available.

In some embodiments, the power supply circuit further includes a control module. The control module is configured to control an operating state of each of the first AC/DC conversion module, the second AC/DC conversion module, and the battery module based on a user instruction.

An energy storage device according to embodiments of the present disclosure includes the power supply circuit according to any of the above embodiments of the present disclosure.

In the energy storage device described above, when the external AC power supply is available, the external AC power supply can output the electrical energy to the AC output interface or charge the battery module. Moreover, the battery module can be used to output the electric energy to the AC output interface regardless of whether the external AC power supply is available or not. In this way, the power supply circuit can simultaneously realize the functions of the online UPS and the standby UPS, thereby making the power supply circuit highly flexible and suitable for the different load requirements.

Additional aspects and advantages of the embodiments of present disclosure will be provided at least in part in the following description, or will become apparent in part from the following description, or can be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings.

FIG. 1 to FIG. 11 are circuit diagrams of a power supply circuit according to an embodiment of the present disclosure.

FIG. 12 is a schematic diagram of modules of an energy storage device according to an embodiment of the present disclosure.

### DESCRIPTION OF REFERENCE NUMERALS OF PRIMARY COMPONENTS

power supply circuit 10, AC input interface 12, first AC/DC conversion module 14a, second AC/DC conversion module 14b, AC output interface 16, first AC output interface 16a, second AC output interface 16b, battery module 18, first branch circuit 20, second branch circuit 22, first switch 24, second switch 26, first AC/DC sub-conversion module 28, first DC/DC conversion module 30, second AC/DC sub-conversion module 32, second DC/DC conversion module 34, control module 36, energy storage device 100.

### DETAILED DESCRIPTION OF THE EMBODIMENTS

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain rather than limit the present disclosure.

Various embodiments or examples for implementing different structures of the embodiments of the present disclosure are provided below. To simplify the embodiments of the present disclosure, components and settings in specific examples are described below. Of course, they are merely exemplary and are not intended to limit the present disclosure. Moreover, the embodiments of the present disclosure may repeat reference numbers and/or reference letters in different examples. Such repetition is for purposes of simplicity and clarity and is in itself indicative of a relationship among the various embodiments and/or settings discussed. In addition, the present disclosure provides examples of various specific processes and materials, but those of ordinary skill in the art may recognize application of other processes and/or use of other materials.

A UPS (Uninterruptible Power System) is a device that can continuously supply power to a load.

The UPS is typically composed of a rectifier, an inverter, a battery group, and an input interface. When an external AC power supply input to the UPS is normal, the external AC power input is configured to supply power to the load through the rectifier and inverter.

When an external AC power supply input to the UPS fails, the battery group is configured to supply power to the load through the inverter by using stored electrical energy of the battery group to ensure a normal output.

The UPSs can be classified into a standby UPS and an online UPS.

In the online UPS, the inverter is constantly in an operation, and power is supplied to the load by the inverter regardless of whether the input power supply is normal or not. This type of UPS has a stable output, but has capacity loss when supplying power to the load by the inverter. Thus, it is suitable for loads with high requirements on power quality.

In the standby UPS, when the input power supply is normal, power is directly supplied by the external AC power supply. When the input power supply is interrupted, power is supplied by a battery module through inversion. This type of UPS has a simple structure and low cost, but is poor in output voltage stability and has a switching time period. Thus, it is suitable for loads that are not sensitive to output voltage and switching time.

However, depending on the type of load, different requirements for the type of UPS may arise. The single online UPS or the single standby UPS cannot adapt to different loads requirements, resulting in poor UPS flexibility and inability to meet user needs in different scenarios.

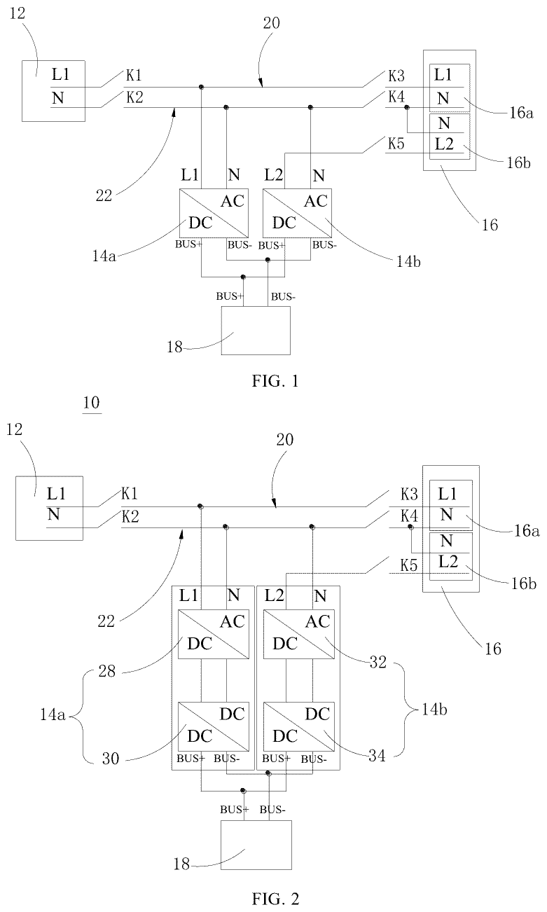

Referring to FIGS. 1 and 2, a power supply circuit 10 according to embodiments of the present disclosure includes an AC input interface 12, a first AC/DC (Alternating Current/Direct Current) conversion module 14a, a second AC/DC conversion module 14b, and an AC output interface 16. The AC input interface 12 is configured to be connected to an external AC power supply. Each of the first AC/DC conversion module 14a and the second AC/DC conversion module 14b is configured to connect to a battery module 18. The AC input interface 12 and the AC output interface 16 are electrically connected to each other to form a first branch circuit 20. The AC input interface 12, the first AC/DC conversion module 14a, the second AC/DC conversion module 14b, and the AC output interface 16 are sequentially electrically connected to form a second branch circuit 22.

The first branch circuit 20 is configured to output electric energy through the AC output interface 16 by using the external AC power supply when the external AC power supply is available. The second branch circuit 22 is configured to output electric energy to the AC output interface 16 through the second branch circuit 22 by using the external AC power supply when the external AC power supply is available, and/or the second branch circuit 22 is configured to output electric energy to the AC output interface 16 through the second AC/DC conversion module 14b by using the battery module 18 when the external AC power supply is available or unavailable.

In the power supply circuit 10 described above, when the external AC power supply is available, the external AC power supply can output the electric energy to the AC output interface 16 or charge the battery module 18. Moreover, the battery module 18 can be used to output the electric energy to the AC output interface 16 regardless of whether the external AC power supply is available or not. In this way, the power supply circuit 10 can simultaneously realize the functions of the online UPS and the standby UPS, thereby making the power supply circuit 10 highly flexible and suitable for the different load requirements.

In an embodiment, the power supply circuit 10 includes the AC input interface 12, the first AC/DC conversion module 14a, the second AC/DC conversion module 14b, and the AC output interface 16. Optionally, the power supply circuit 10 can be applied in an energy storage device 100, a power supply device, or other electronic devices with internally arranged rechargeable batteries.

The AC input interface 12 is configured to be electrically connected to the external AC power supply. A conversion module 14 is connected to the battery module 18 that is capable of supplying power.

The AC input interface 12 is connected to the first AC output interface 16a and is connected to the second AC output interface 16b via the first conversion module 14a and the second conversion module 14b. Each of the first AC/DC conversion module 14a and the second AC/DC conversion module 14b is configured to convert an alternating current input from the external AC power supply into a direct current to charge the battery module 18. Each of the first AC/DC conversion module 14a and the second AC/DC conversion module 14b is further configured to convert a direct current provided by the battery module 18 into an alternating current to supply power to the AC output interface 16.

The AC output interface 16 is connected to the load, and each of the external AC power supply and the battery module 18 is configured to supply power to the load through the AC output interface 16.

When the external AC power supply is available, the external AC power supply input can supply power to the AC output interface 16 through the first branch circuit 20 while charging the battery module 18 through the first AC/DC conversion module 14a.

In this case, if the external AC power supply is disconnected, the first branch circuit 20 is de-energized, the battery module 18 is switched into a discharging mode from a charging mode, and the first AC/DC conversion module 14a is switched into an inversion mode of DC-AC conversion from a rectification mode of AC-DC conversion. This process takes a certain time interval. For the load, the power supply is suspended for a period of time. At this time, the power supply circuit 10 can realize the function of the standby UPS.

When the external AC power supply is available, the battery module 18 can also supply power to the AC output interface 16 via the second AC/DC conversion module 14b, or the battery module 18 and the external AC power supply can supply power to the AC output interface 16 together.

In this case, even if the external AC power supply is cut off, the battery module 18 can continue to supply power to the load as long as output power of the battery module 18 is greater than or equal to required power of the load and the battery module 18 has sufficient charge. The second AC/DC conversion module 14b is constantly in the AC-DC conversion process without any time interval, enabling 0 ms power supply to the load. At this time, the power supply circuit 10 can realize the function of the online UPS.

It should be noted that when the battery module 18 and the external AC power supply jointly supply power to the AC output interface 16 and the external AC power supply is a mains input, an output of the battery module 18 needs to be processed to be connected to a mains grid. Only in this way can the battery module 18 and the mains input jointly supply the power to the AC output interface 16.

In summary, the power supply circuit 10 can realize the function of the online UPS or the function of the standby UPS. In this way, the operating mode of the power supply circuit 10 can be adjusted based on actual load requirements, making the power supply circuit 10 highly flexible and suitable for the different load requirements.

In some embodiments, the AC output interface 16 includes a first AC output interface 16a and a second AC output interface 16b. The AC input interface 12 and the first AC output interface 16a are connected to each other to form the first branch circuit 20. The AC input interface 12, the first AC/DC conversion module 14a, the second AC/DC conversion module 14b, and the second AC output interface 16b are sequentially electrically connected to form the second branch circuit 22.

In this way, the AC input interface 12 is connected to the first AC output interface 16a, and the AC input interface 12 is connected to the second AC output interface 16b through the first conversion module 14a and the second conversion module 14b, allowing for the function of the standby UPS and the function of the online UPS functions respectively.

In an embodiment, the first AC/DC conversion module 14a is connected to the battery module 18, and the second AC/DC conversion module 14b is further connected to the battery module 18 and the second AC output interface 16b.

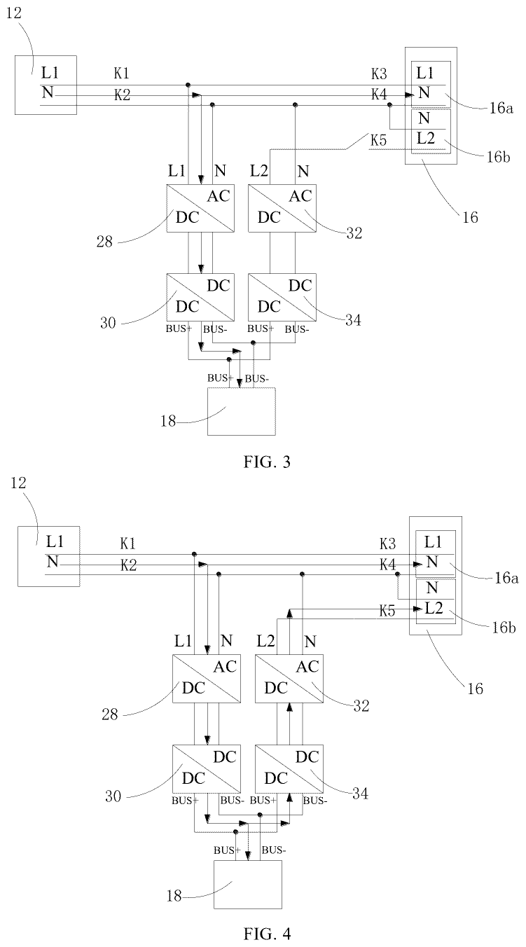

When the external AC power supply is available, the alternating current provided by the external AC power supply can be directly supplied to the first AC output interface 16a through the first branch circuit 20, as illustrated in FIG. 3. In this case, the first AC/DC conversion module 14a is in the rectification mode, converting an alternating current into a direct current to charge the battery module 18.

When the external AC power supply is unavailable, power is supplied to the first AC output interface 16a from the power supply, and the first AC/DC conversion module 14a is switched into the inversion mode from the rectification mode to convert the direct current provided by the power supply into the alternating current. In this case, a conversion time period is required, that is, the first AC output interface 16a is a standby UPS interface, as illustrated in FIG. 6.

Further, in the power supply process described above, when there is a power demand at the second AC output interface 16b, if power supplied by the external AC power supply is greater than or equal to a sum of output power of the first AC output interface 16a and the second AC output interface 16b, then after the alternating current from the external AC power supply passes through the first AC/DC conversion module 14a, part of it is supplied to the second AC interface through the second AC/DC conversion module 14b, and another part of it charges the battery module 18, as illustrated in FIG. 4.

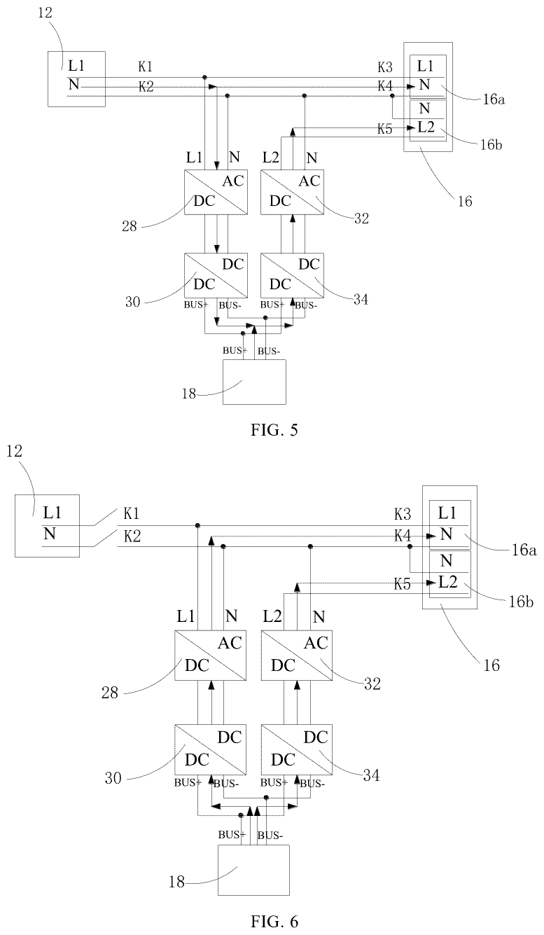

If the power supplied by the external AC power supply is smaller than the sum of the output power of the first AC output interface 16a and the second AC output interface 16b, the battery module 18 can supply power to the second AC output interface 16b through the second AC/DC conversion module 14b. In this case, power is supplied to the first AC interface from the alternating current of the external AC power supply, and the battery module 18 is simultaneously charged through the first AC/DC conversion module 14a. Meanwhile, the battery module 18 supplies power to the second AC output interface 16b through the second AC/DC conversion module 14b, as illustrated in FIG. 5.

Since the second AC/DC conversion module 14b is constantly in the inversion mode, if the external AC power supply is unavailable in this case, the battery module 18 can continuously supply power to the second AC output interface 16b. In this way, the second AC output interface 16b serves as an online UPS interface, as illustrated in FIG. 6.

Thus, in a power supply circuit 10, the first AC output interface 16a can serve as the standby UPS interface, and the second AC output interface 16b can serve as the online UPS interface. A user can make selections based on the actual load requirements to connect the load to the first AC output interface 16a or the second AC output interface 16b.

In some embodiments, the first AC/DC conversion module 14a includes a first AC/DC sub-conversion module 28 and a first DC/DC conversion module 30 connected to the first AC/DC sub-conversion module 28, the second AC/DC conversion module 14b includes a second AC/DC sub-conversion module 32 and a second DC/DC conversion module 34 connected to the second AC/DC sub-conversion module 32. The first AC/DC sub-conversion module 28 is connected to the AC input interface 12. The second AC/DC sub-conversion module 32 is connected to the second AC output interface 16b. The first DC/DC conversion module and the second DC/DC conversion module are connected to each other and are both connected to the battery module.

In this way, the input and the output of the direct current can be made more stable.

In an embodiment, the first DC/DC conversion module 30 can output a stable DC voltage, which is not affected by input voltage fluctuations and load changes. The first DC/DC conversion module 30 can adjust the output voltage to ensure that the battery module 18 operates normally and stably.

The second DC/DC conversion module 34 can output a stable DC voltage, which is not affected by input voltage fluctuations and load changes. The second DC/DC conversion module 34 can adjust the output voltage to ensure that the battery module 18 operates normally and stably.

Meanwhile, when the second AC output interface 16b is the online UPS, or when both the first AC output interface 16a and the second AC output interface 16b are the online UPS, the power supply supplies power to the second AC output interface 16b or both the first AC output interface 16a and the second AC output interface 16b through the second DC/DC conversion module 34 and the second AC/DC sub-conversion module 32. In this case, the external AC power supply charges the battery module 18 through the first AC/DC conversion module 14a.

In this way, when the external AC power supply is distorted or interfered, it is transmitted to the battery module 18 through the first AC/DC conversion module 14a and absorbed by the battery module 18, and the battery module 18 can maintain a stable voltage output to supply power to the second AC output interface 16b or both the first AC output interface 16a and the second AC output interface 16b. Thus, quality of electric energy outputted by the second AC output interface 16b or both the first AC output interface 16a and the second AC output interface 16b can be guaranteed.

In some embodiments, the power supply circuit 10 further includes a first switch 24 disposed between the first AC/DC sub-conversion module 28 and the second AC/DC sub-conversion module 32. The first switch 24 is configured to control the first AC/DC sub-conversion module 28 to be in conduction with or to be not in conduction with the second AC/DC sub-conversion module 32. The AC input interface 12 is connected to the first AC/DC conversion module 14a and the second AC/DC conversion module 14b. When the first switch 24 is turned on, two-phase power is inputted through the AC input interface 12 and supplied to the battery module 18 through the first AC/DC conversion module 14a and the second AC/DC conversion module 14b.

In this way, the power supply circuit 10 can realize a two-phase charging function for the battery module 18.

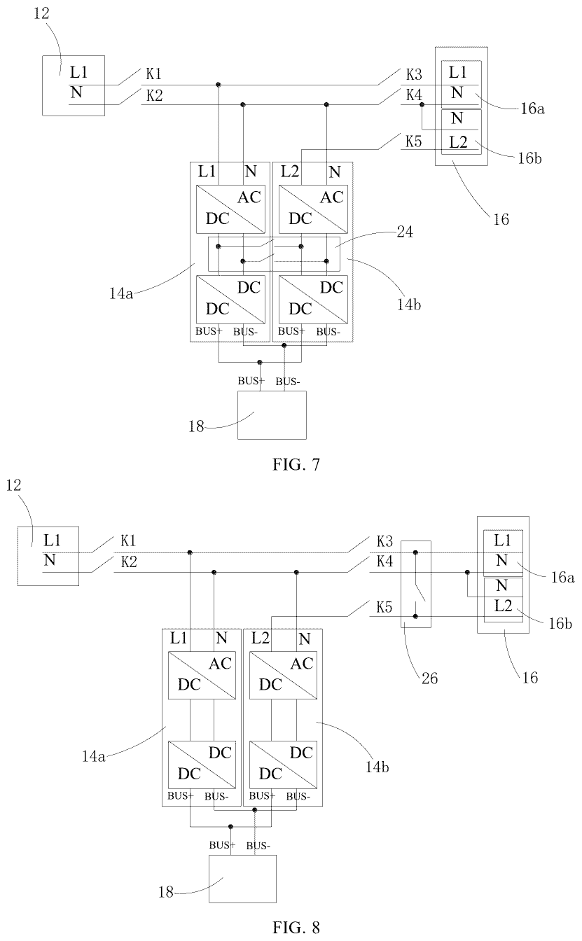

In an embodiment, as illustrated in FIG. 7, the AC input interface 12 is connected to the first AC/DC conversion module 14a and the second AC/DC conversion module 14b through a live wire terminal L1 and a neutral wire terminal N, respectively, and the first AC/DC conversion module 14a and the second AC/DC conversion module 14b are connected to the battery module 18 through a DC bus (positive DC bus BUS+, negative DC bus BUS−). The first switch 24 includes a first sub-switch and a second sub-switch. The first sub-switch is disposed between the live wire terminal L1 of the first AC/DC conversion module 14a and the live wire terminal L2 of the second AC/DC conversion module 14b. The second sub-switch is disposed between the neutral wire terminal N of the first AC/DC conversion module 14a and the neutral wire terminal N of the second AC/DC conversion module 14b.

When a voltage between the live wire terminal L1 and the neutral wire terminal N of the AC input interface 12 is 120V, the AC input interface 12 can realize a two-phase input. In an embodiment, transmission is carried out through two live wires and one neutral wire. A phase difference of a voltage between the two live wires is 180 degrees. One of the two live wires is connected to the first AC/DC conversion module 14a, and another one of the two live wires is connected to the second AC/DC conversion module 14b. When the first sub-switch and the second sub-switch are closed, a voltage between the live wire terminal L1 of the first AC/DC conversion module 14a and the live wire terminal L2 of the second AC/DC conversion module 14b is 240V, and power is supplied to the battery module 18. That is, when the first switch 24 is turned on, the power supply circuit 10 can realize the two-phase charging function for the battery module 18, and the input to the battery module 18 has a higher voltage and output current. In this way, a faster charging speed can be provided.

When the first switch 24 is turned off, the power supply circuit 10 realizes the above-mentioned function of supplying the power to the AC output interface 16.

In some embodiments, the power supply circuit 10 further includes a second switch 26 disposed between the first AC output interface 16a and the second AC output interface 16b. The second switch 26 is configured to enable the first AC output interface 16a to be in conduction with or to be not in conduction with the second AC output interface 16b. When the second switch 26 is turned on, the first AC output interface 16a and the second AC output interface 16b are simultaneously powered by the AC input interface 12.

In this way, the first AC output interface 16a and the second AC output interface 16b can simultaneously serve as the online UPS interfaces or the standby UPS interfaces.

In an embodiment, as illustrated in FIG. 8, in the first branch circuit 20, the AC input interface 12 is connected to the first AC output interface 16a through the live wire terminal L1 and the neutral wire terminal N; in the second branch circuit 22, the second AC/DC conversion module 14b is connected to the second AC output interface 16b through the live wire terminal L1 and the neutral wire terminal N; the second switch 26 is disposed between the live wire terminal L1 of the first branch circuit 20 and the live wire terminal L1 of the second branch circuit 22. In this way, the first AC output interface 16a and the second AC output interface 16b can simultaneously serve as the online UPS interfaces or the standby UPS interfaces.

In some embodiments, when the second switch 26 is turned on, one of the first branch circuit 20 and the second branch circuit 22 is switched on, and another one of the first branch circuit 20 and the second branch circuit 22 is switched off.

In this way, the power supply modes of the first AC output interface 16a and the second AC output interface 16b can be controlled based on the on/off states of the first branch circuit 20 and the second branch circuit 22.

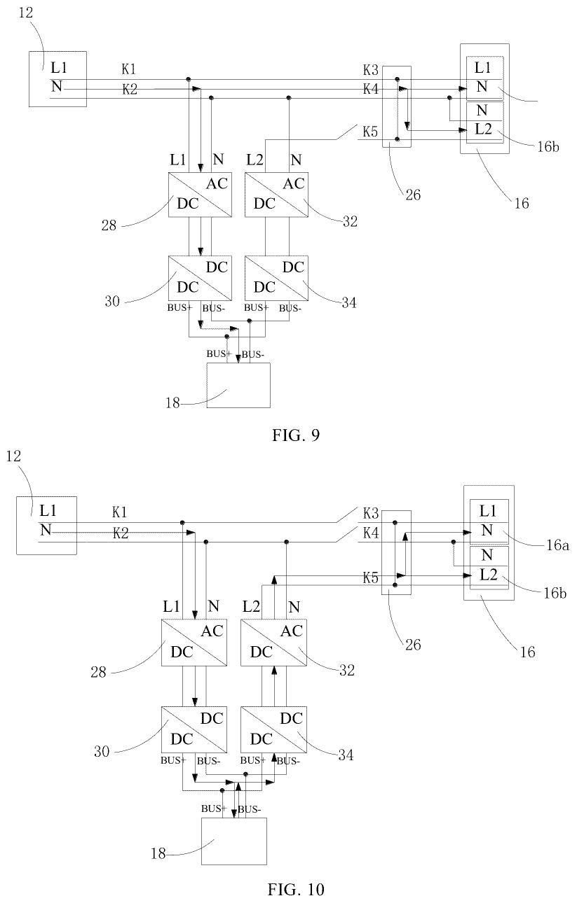

In an embodiment, as illustrated in FIG. 9, when the second switch 26 is turned on, the alternating current input from the external AC power supply is supplied to the first AC output interface 16a through the first branch circuit 20, and the power can be simultaneously supplied to the second AC output interface 16b through the second switch 26 that is turned on. Meanwhile, the external AC power supply supplies power to the battery module 18 through the first AC/DC conversion module 14a. Based on the previous analysis, after the external AC power supply is unavailable, the first AC/DC conversion module 14a is switched to the inversion mode from the rectifier module with a switching time interval. After the first AC/DC conversion module 14a is switched to the inversion mode, power is simultaneously supplied to the first AC output interface 16a and the second AC output interface 16b. In this way, the first AC output interface 16a and the second AC output interface 16b can simultaneously serve as the standby UPS interfaces.

As illustrated in FIG. 10, when the second switch 26 is turned on, the battery module 18 supplies power to the second AC output interface 16b through the second AC/DC conversion module 14b, and simultaneously supplies power to the first AC output interface 16a through the second switch 26 that is turned on. Meanwhile, the external AC power supply can also supply power to the battery module 18 through the first AC/DC conversion module 14a. Thus, based on the previous analysis, after the external AC power supply is unavailable, the battery module 18 can continuously supply the power to the first AC output interface 16a and the second AC output interface 16b without being affected by the external AC power supply. Thus, the first AC output interface 16a and the second AC output interface 16b can simultaneously serve as the online UPS interfaces.

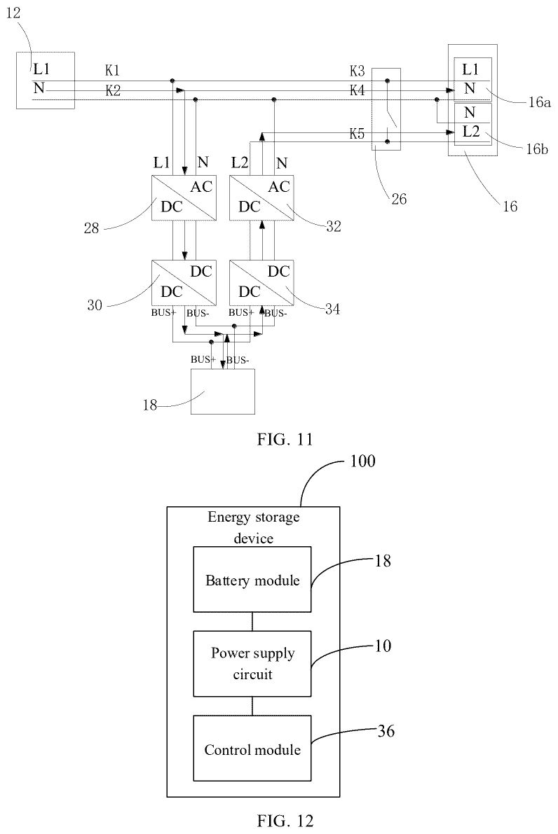

As illustrated in FIG. 11, when the second switch 26 is turned off, it is possible to realize that the first AC output interface 16a serves as the standby UPS interface and the second AC output interface 16b serves as the online UPS interface, based on the previous analysis.

In some embodiments, the power supply circuit 10 further includes a third AC output interface. The AC input interface 12 includes a first live wire terminal and a second live wire terminal. The third AC output interface includes a third live wire terminal and a fourth live wire terminal. When power is supplied to the third AC output interface from the battery module 18, the third live wire terminal is connected to the first AC/DC conversion module 14a, and the fourth live wire terminal is connected to the second AC/DC conversion module 14b. When power is supplied to the third AC output interface from the AC input interface 12, the first live wire terminal is connected to the third live wire terminal, and the second live wire terminal is connected to the fourth live wire terminal.

In this way, by simultaneously outputting the alternating current through the third live wire terminal and the fourth live wire terminal of the third AC output interface, a voltage output of 240V can be realized, which can meet a greater load power requirement.

In an embodiment, the AC input interface 12 can output split-phase power. For example, a voltage of 120V can be output between the first live wire terminal and a neutral wire terminal of the AC input interface 12, and a voltage of 240V can be output between the first live wire terminal and the second live wire terminal of the AC input interface 12.

When the power is supplied to the third AC output interface from the battery module 18, the third live wire terminal is connected to the first AC/DC conversion module 14a, and the fourth live wire terminal is connected to the second AC/DC conversion module 14b. In this case, a direct current provided by a battery is converted into an alternating current by the first AC/DC conversion module 14a and the second AC/DC conversion module 14b, and a voltage of 240V can be output between the third live wire terminal and the fourth live wire terminal of the third AC output interface.

When the power is supplied to the third AC output interface from the AC input interface 12, the first live wire terminal is connected to the third live wire terminal, and the second live wire terminal is connected to the fourth live wire terminal. The AC input interface 12 can directly supply the power to the third AC output interface, allowing for a voltage of 240V output between the third live wire terminal and the fourth live wire terminal of the third AC output interface. In this way, the greater load power requirements can be met, thereby providing the power supply circuit 10 with more versatile usage scenarios.

In some embodiments, the second branch circuit 22 is configured to charge the battery module 18 by using the second branch circuit 22 when the external AC power supply is available.

In this way, the battery module 18 can be charged when the external AC power supply is available.

In an embodiment, the battery module 18 can supply power to the AC output interface 16. For example, when the external AC power supply is unavailable or during peak electricity pricing hours, the battery module 18 may be selected to supply the power to the AC output interface 16.

In order to ensure that the battery module 18 maintains sufficient charge for use when needed, when the external AC power supply is available, the second branch circuit 22 is configured to charge the battery module 18 through the first AC/DC conversion module 14a. In an embodiment, an alternating current provided by the external AC power supply is converted into a direct current through the first AC/DC conversion module 14a to charge the battery module 18.

Referring to FIG. 1, in some embodiments, the first AC/DC conversion module 14a includes a first AC/DC sub-conversion module 28 connected to the first AC input interface 12 and the battery module 18.

In this way, the first AC/DC sub-conversion module 28 can perform an AC-DC conversion between the external AC power supply and the battery module 18.

In an embodiment, the first AC/DC sub-conversion module 28 has a rectification mode and an inversion mode. In the rectification mode, the first AC/DC sub-conversion module 28 can be configured to convert an alternating current provided by the external AC power supply into a direct current to charge the battery module 18. In the inversion mode, the first AC/DC sub-conversion module 28 can be configured to convert a direct current provided by the battery module 18 into an alternating current to supply power to the AC output interface 16.

Referring to FIG. 1, in some embodiments, the second AC/DC conversion module 14b includes a second AC/DC sub-conversion module 32 connected to the second AC input interface 12 and the battery module 18.

In this way, the second AC/DC sub-conversion module 32 can perform an AC-DC conversion between the external AC power supply and the battery module 18.

In an embodiment, the second AC/DC sub-conversion module 32 has a rectification mode and an inversion mode. In the rectification mode, the second AC/DC sub-conversion module 32 can be configured to convert an alternating current provided by the external AC power supply into a direct current to charge the battery module 18. In the inversion mode, the second AC/DC sub-conversion module 32 can be configured to convert a direct current provided by the battery module 18 into an alternating current to supply power to the AC output interface 16.

In some embodiments, the power supply circuit 10 further includes a control module 36, and the control module 36 is configured to control an operating state of each of the conversion module 14 and the battery module 18 based on a user instruction.

In this way, the control module 36 can control the operating state of each of the conversion module 14 and the battery module 18 based on user requirements. Thus, the AC output interface 16 can be in the operating state required by the user.

In an embodiment, power is supplied to connected loads by the first AC output interface 16a and the second AC output interface 16b, and the user can select a power supply type of the first AC output interface 16a and the second AC output interface 16b based on a type of the load.

In an embodiment, the power supply circuit 10 is disposed in the energy storage device 100. The energy storage device 100 has a charging interface and a power supply interface. The charging interface is connected to the AC input interface 12. The power supply interface may include a first power supply interface and a second power supply interface. The first power supply interface is connected to the first AC output interface 16a, and the second power supply interface is connected to the second AC output interface 16b. In this way, the energy storage device 100 can realize the functions of the different types of UPSs described above.

That is, the first power supply interface is the standby UPS interface, and the second power supply interface is the online UPS interface; or the first power supply interface and the second power supply interface are both the standby UPS interfaces; or the first power supply interface and the second power supply interface are both the online UPS interfaces.

The energy storage device 100 has a control panel that can interact with the user. The control panel is connected to the control module 36, and the user can make selections as needed. The control module 36 is configured to control the conversion module 14 and the battery module 18 to be in corresponding operating states in response to the user instruction.

In some embodiments, the conversion module further includes a switch module. The switch module includes an input switch module and an output switch module. The input switch module is disposed at the AC input interface 12 and includes an input switch K1 and an input switch K2. As illustrated in FIGS. 1 and 2, the live wire terminal L1 of the AC input interface 12 is connected to the input switch K1, and the neutral wire terminal N of the AC input interface 12 is connected to the input switch K2. The output switch module is disposed at the AC output interface 12 and includes an output switch K3, an output switch K4, and an output switch K5. As illustrated in FIGS. 1 and 2, the live wire terminal L1 of the first AC output interface 16a is connected to the output switch K3, the live wire terminal L2 of the second AC output interface 16b is connected to the output switch K5, and the neutral wire terminal N of the first AC output interface 16a and the neutral wire terminal N of the second AC output interface 16b are connected to each other and are both connected to the output switch K4.

In this way, the control module 36 can control the switch module to be switched on and off, thereby controlling power-on and power-off states of the power supply circuit 10 with the external AC power supply and the load.

An energy storage device 100 according to an embodiment of the present disclosure includes the power supply circuit 10 according to any one of the above embodiments of the present disclosure.

In the energy storage device 100 described above, when the external AC power supply is available, the external AC power supply can output the electrical energy to the AC output interface 16 or charge the battery module 18. Moreover, the battery module 18 can be used to output the electric energy to the AC output interface 16 regardless of whether the external AC power supply is available or not. In this way, the power supply circuit 10 can simultaneously realize the functions of the online UPS and the standby UPS, thereby making the power supply circuit 10 highly flexible and suitable for the different load requirements.

In an embodiment, by configuring the power supply circuit 10, the energy storage device 100 can obtain the electrical energy from the external source, such as from a power grid, a generator, and an energy storage device connected to a power supply device, and output the alternating current externally. The energy storage device 100 can also store the obtained electrical energy in a rechargeable battery in the energy storage device 100.

It should be noted that the above description of the embodiments and advantageous effects of the power supply circuit 10 is also applicable to the energy storage device 100 of this embodiment of the present disclosure, and details thereof will not be described herein to avoid redundancy.

In the description of this specification, descriptions with reference to the terms “an embodiment”, “some embodiments”, “an exemplary embodiment”, “an example”, “a specific example”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. A power supply circuit, comprising an alternating current, AC, input interface, a first AC/direct current, DC, conversion module, a second AC/DC conversion module, and an AC output interface, the AC input interface being configured to be connected to an external AC power supply, each of the first AC/DC conversion module and the second AC/DC conversion module being configured to be connected to a battery module, the AC input interface and the AC output interface being electrically connected to each other to form a first branch circuit, the AC input interface, the first AC/DC conversion module, the second AC/DC conversion module, and the AC output interface being sequentially electrically connected to form a second branch circuit, wherein:
the first branch circuit is configured to output electric energy through the AC output interface by using the external AC power supply when the external AC power supply is available; and
the second branch circuit is configured to output electric energy to the AC output interface through the second branch circuit by using the external AC power supply when the external AC power supply is available, and/or the second branch circuit is configured to output electric energy to the AC output interface through the second AC/DC conversion module by using the battery module when the external AC power supply is available or unavailable.

2. The power supply circuit according to claim 1, wherein:
the AC output interface comprises a first AC output interface and a second AC output interface;
the AC input interface and the first AC output interface are connected to each other to form the first branch circuit; and
the AC input interface, the first AC/DC conversion module, the second AC/DC conversion module, and the second AC output interface are sequentially electrically connected to form the second branch circuit.

3. The power supply circuit according to claim 2, wherein:
the first AC/DC conversion module comprises a first AC/DC sub-conversion module and a first DC/DC conversion module connected to the first AC/DC sub-conversion module; and
the second AC/DC conversion module comprises a second AC/DC sub-conversion module and a second DC/DC conversion module connected to the second AC/DC sub-conversion module, wherein:
the first AC/DC sub-conversion module is connected to the AC input interface;
the second AC/DC sub-conversion module is connected to the second AC output interface; and
the first DC/DC conversion module and the second DC/DC conversion module are connected to each other and are both connected to the battery module.

4. The power supply circuit according to claim 3, further comprising a first switch disposed between the first AC/DC sub-conversion module and the second AC/DC sub-conversion module, the first switch being configured to control the first AC/DC sub-conversion module to be in conduction with or to be not in conduction with the second AC/DC sub-conversion module,
wherein the AC input interface is connected to the first AC/DC conversion module and the second AC/DC conversion module; and
when the first switch is turned on, two-phase power is inputted through the AC input interface and supplied to the battery module through the first AC/DC conversion module and the second AC/DC conversion module.

5. The power supply circuit according to claim 2, further comprising a second switch disposed between the first AC output interface and the second AC output interface, the second switch being configured to enable the first AC output interface to be in conduction with or to be not in conduction with the second AC output interface,
wherein when the second switch is turned on, the first AC output interface and the second AC output interface are simultaneously powered through the AC input interface.

6. The power supply circuit according to claim 5, wherein when the second switch is turned on, one of the first branch circuit and the second branch circuit is switched on, and another one of the first branch circuit and the second branch circuit is switched off.

7. The power supply circuit according to claim 2, further comprising a third AC output interface,
wherein the AC input interface comprises a first live wire terminal and a second live wire terminal;
the third AC output interface comprises a third live wire terminal and a fourth live wire terminal;
when power is supplied to the third AC output interface from the battery module, the third live wire terminal is connected to the first AC/DC conversion module, and the fourth live wire terminal is connected to the second AC/DC conversion module; and
when power is supplied to the third AC output interface from the AC input interface, the first live wire terminal is connected to the third live wire terminal, and the second live wire terminal is connected to the fourth live wire terminal.

8. The power supply circuit according to claim 1, wherein the second branch circuit is further configured to charge the battery module by using the second branch circuit when the external AC power supply is available.

9. The power supply circuit according to claim 1, further comprising a control module, wherein the control module is configured to control an operating state of each of the first AC/DC conversion module, the second AC/DC conversion module, and the battery module based on a user instruction.

10. The power supply circuit according to claim 1, wherein:
each of the first AC/DC conversion module and the second AC/DC conversion module is configured to convert an alternating current inputted from the external AC power supply into a direct current to charge the battery module; and
each of the first AC/DC conversion module and the second AC/DC conversion module is further configured to convert a direct current provided by the battery module into an alternating current to supply power to the AC output interface.

11. An energy storage device, comprising a power supply circuit,
wherein the power supply circuit comprises an AC input interface, a first AC/DC conversion module, a second AC/DC conversion module, and an AC output interface, the AC input interface being configured to be connected to an external AC power supply, each of the first AC/DC conversion module and the second AC/DC conversion module being configured to be connected to a battery module, the AC input interface and the AC output interface being electrically connected to each other to form a first branch circuit, the AC input interface, the first AC/DC conversion module, the second AC/DC conversion module, and the AC output interface being sequentially electrically connected to form a second branch circuit;
the first branch circuit is configured to output electric energy through the AC output interface by using the external AC power supply when the external AC power supply is available; and
the second branch circuit is configured to output electric energy to the AC output interface through the second branch circuit by using the external AC power supply when the external AC power supply is available, and/or the second branch circuit is configured to output electric energy to the AC output interface through the second AC/DC conversion module by using the battery module when the external AC power supply is available or unavailable.

12. The energy storage device according to claim 11, wherein:
the AC output interface comprises a first AC output interface and a second AC output interface;
the AC input interface and the first AC output interface are connected to each other to form the first branch circuit; and
the AC input interface, the first AC/DC conversion module, the second AC/DC conversion module, and the second AC output interface are sequentially electrically connected to form the second branch circuit.

13. The energy storage device according to claim 12, wherein:
the first AC/DC conversion module comprises a first AC/DC sub-conversion module and a first DC/DC conversion module connected to the first AC/DC sub-conversion module; and
the second AC/DC conversion module comprises a second AC/DC sub-conversion module and a second DC/DC conversion module connected to the second AC/DC sub-conversion module, wherein:
the first AC/DC sub-conversion module is connected to the AC input interface;
the second AC/DC sub-conversion module is connected to the second AC output interface; and
the first DC/DC module and the second DC/DC module are connected to each other and are both connected to the battery module.

14. The energy storage device according to claim 13, wherein the power supply circuit further comprises a first switch disposed between the first AC/DC sub-conversion module and the second AC/DC sub-conversion module, the first switch being configured to control the first AC/DC sub-conversion module to be in conduction with or to be not in conduction with the second AC/DC sub-conversion module;
the AC input interface is connected to the first AC/DC conversion module and the second AC/DC conversion module; and
when the first switch is turned on, two-phase power is inputted through the AC input interface and supplied to the battery module through the first AC/DC conversion module and the second AC/DC conversion module.

15. The energy storage device according to claim 12, wherein the power supply circuit further comprises a second switch disposed between the first AC output interface and the second AC output interface, the second switch being configured to enable the first AC output interface to be in conduction with or to be not in conduction with the second AC output interface; and
when the second switch is turned on, the first AC output interface and the second AC output interface are simultaneously powered through the AC input interface.

16. The energy storage device according to claim 15, wherein when the second switch is turned on, one of the first branch circuit and the second branch circuit is switched on, and another one of the first branch circuit and the second branch circuit is switched off.

17. The energy storage device according to claim 12, wherein the power supply circuit further comprises a third AC output interface;
the AC input interface comprises a first live wire terminal and a second live wire terminal;
the third AC output interface comprises a third live wire terminal and a fourth live wire terminal;
when power is supplied to the third AC output interface from the battery module, the third live wire terminal is connected to the first AC/DC conversion module, and the fourth live wire terminal is connected to the second AC/DC conversion module; and
when power is supplied to the third AC output interface from the AC input interface, the first live wire terminal is connected to the third live wire terminal, and the second live wire terminal is connected to the fourth live wire terminal.

18. The energy storage device according to claim 11, wherein the second branch circuit is further configured to charge the battery module by using the second branch circuit when the external AC power supply is available.

19. The energy storage device according to claim 11, wherein the power supply circuit further comprises a control module configured to control an operating state of each of the first AC/DC conversion module, the second AC/DC conversion module, and the battery module based on a user instruction.

20. The energy storage device according to claim 11, wherein:
each of the first AC/DC conversion module and the second AC/DC conversion module is configured to convert an alternating current input from the external AC power supply into a direct current to charge the battery module; and
each of the first AC/DC conversion module and the second AC/DC conversion module is further configured to convert a direct current provided by the battery module into an alternating current to supply power to the AC output interface.
